(19) United States
(12) Patent Application Publication
(10) Pub. No.: US 2014/0125242 A1
(43) Pub. Date: May 8, 2014

(54) ILLUMINATION SYSTEM

(71) Applicant: SAMSUNG ELECTRONICS CO., LTD., Suwon-si (KR)

(72) Inventors: Dae Sung KANG, Suwon-si (KR); Yun Whan NA, Yongin-si (KR); Dae Yeop PARK, Hwaseong-si (KR); In Gu HAN, Seoul (KR)

(73) Assignee: SAMSUNG ELECTRONICS CO., LTD., Suwon-si (KR)

(21) Appl. No.: 14/073,139

(22) Filed: Nov. 6, 2013

(30) Foreign Application Priority Data
Nov. 6, 2012 (KR) 10-2012-0124636

(51) Int. Cl. H05B 33/08

(52) U.S. Cl. CPC H05B 33/0806
USPC 315/201

(57) ABSTRACT

There is provided an illumination system including a driving device including a rectifier configured to receive alternating current (AC) power from an external power source, rectify the AC power, and output rectified power, and a constant current driver configured to receive the rectified power from the rectifier and output constant current; a light emitting device including at least one light emitting diode (LED) driven with the constant current of the driving device, and a forward direction current transmitter configured to control the constant current of the driving device to be applied to the LED in a forward direction; and a detachable electrical connector connecting the driving device and the light emitting device to one another.

### RELATED APPLICATION

This application claims priority from Korean Patent Application No. 10-2012-0124636 filed on Nov. 6, 2012, with the Korean Intellectual Property Office, the disclosure of which is incorporated herein by reference.

### BACKGROUND

Exemplary embodiments relate to illumination systems.

An illumination device is driven with alternating current (AC) power and includes a stabilizer converting commercial AC power into power having a relatively low voltage. Meanwhile, a light emitting diode (LED) is driven with direct current (DC) power. There is a need for a separate driving circuit for producing constant current from the AC power. However, such a separate driving circuit occupies a certain amount of volume within a light emitting device, which hinders the miniaturization of the light emitting device and decreases the area available for light emission and heat dissipation. In addition, if the lifespans of the driving circuit and the light emitting device are different, when either of which expires, the entirety of such an illumination device should be replaced. Therefore, a method of miniaturizing the circuit built into the light emitting device and extending the replacement period of the illumination device is needed.

### SUMMARY

Exemplary embodiments provide an illumination system, in which a circuit built into a light emitting device is miniaturized, having a replacement period is extended and a high degree of freedom in functional design is achieved.

According to an aspect of an exemplary embodiment, an illumination system may include a driving device including a rectifier configured to receive alternating current (AC) power from an external power source, rectify the AC power, and output rectified power, and a constant current driver configured to receive the rectified power from the rectifier and output a constant current; a light emitting device including at least one light emitting diode (LED) driven with the constant current of the driving device, and a forward direction current transmitter configured to control the constant current of the driving device to be applied to the LED in a forward direction; and a detachable electrical connector connecting the driving device and the light emitting device to one another.

The detachable electrical connector may comprise a socket disposed in the driving device and a plug disposed in the light emitting device, or may comprise a plug disposed in the driving device and a socket disposed in the light emitting device.

The constant current driver may comprise a comparator configured to receive a signal output from the light emitting device, compare the output signal with a preset reference signal, and output a comparison signal, and the constant current driver may control a level of the constant current based on the comparison signal of the comparator.

The comparator may comprise a receiver configured to receive the preset reference signal from an external source.

The signal output from the light emitting device comprises information about at least one from among an amount of light output from the light emitting device, an amount of heat emitted from the light emitting device, a current value applied from the light emitting device to the driving device, and a voltage value applied from the light emitting device to the driving device.

The illumination system may further include an operation controller configured to receive an operation control signal from an external source and control at least one from among on/off operations of the driving device and a level of the constant current output from the driving device.

The operation controller may comprise a wireless communications device, and receive the operation control signal from the external source through the wireless communications device.

The driving device may further comprise a current regulator configured to vary an amount of the constant current outputted from the constant current driver and applied to the light emitting device.

The current regulator may comprise a variable resistor.

The driving device may further comprise a filter configured to reduce noise in the rectified power output from the rectifier, and the constant current driver may receive the power output from the filter and outputs the constant current.

The filter may be a low pass filter.

The driving device may further comprise a dimmer compatible device, and the dimmer compatible device may be configured to receive AC power dimmed by a dimmer included in the external power source.

The forward direction current transmitter may comprise a bridge diode.

The light emitting device may further comprise a protection circuit configured to prevent an overcurrent from being applied to the LED.

According to an aspect of an exemplary embodiment, an illumination system may include a driving device including a rectifier configured to receive alternating current (AC) power from an external power source, rectify the AC power, and output rectified power, and a constant current driver configured to receive the rectified power from the rectifier and output constant current; a light emitting device including at least one first LED driven with the constant current of the driving device, and at least one second LED connected to the at least one first LED in parallel while making an opposite polarity connection; and a detachable electrical connector connecting the driving device and the light emitting device to one another.

### BRIEF DESCRIPTION OF THE DRAWINGS

The above and other aspects, features and other advantages of the exemplary embodiments will be more clearly understood from the following detailed description taken in conjunction with the accompanying drawings, in which:

FIG. 1 is a block diagram of an illumination system according to an exemplary embodiment;

FIGS. 2A and 2B are views illustrating examples of an electrical connector according to an exemplary embodiment;

FIGS. 3 through 11 are block diagrams of illumination systems according to exemplary embodiments;

FIG. 12 is a block diagram of an illumination system according to another exemplary embodiment; and

FIG. 13 is a circuit diagram of the illumination system of FIG. 1.

### DETAILED DESCRIPTION OF THE EXEMPLARY EMBODIMENTS

Exemplary embodiments will now be described in detail with reference to the accompanying drawings.

The disclosure may, however, be exemplified in many different forms and should not be construed as being limited to the exemplary embodiments set forth herein. Rather, the exemplary embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

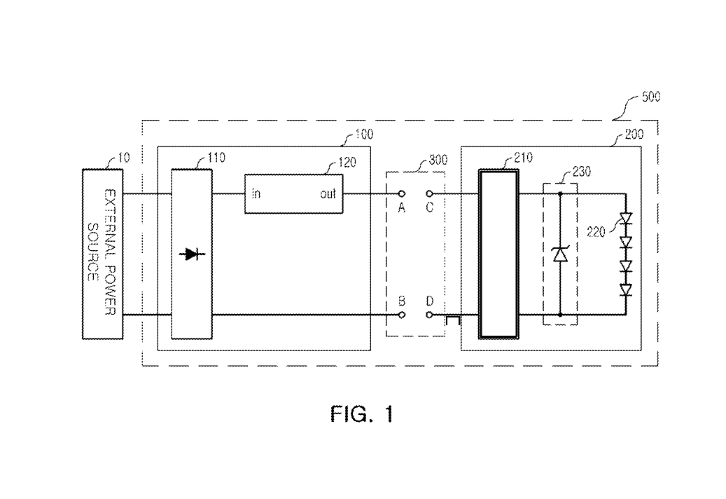

FIG. 1 is a block diagram of an illumination system according to an exemplary embodiment.

With reference to FIG. 1, an illumination system 500 according to an exemplary embodiment may include a driving device 100, a light emitting device 200, and an electrical connector 300 allowing the driving device 100 and the light emitting device 200 to be detachably and electrically connected to one another.

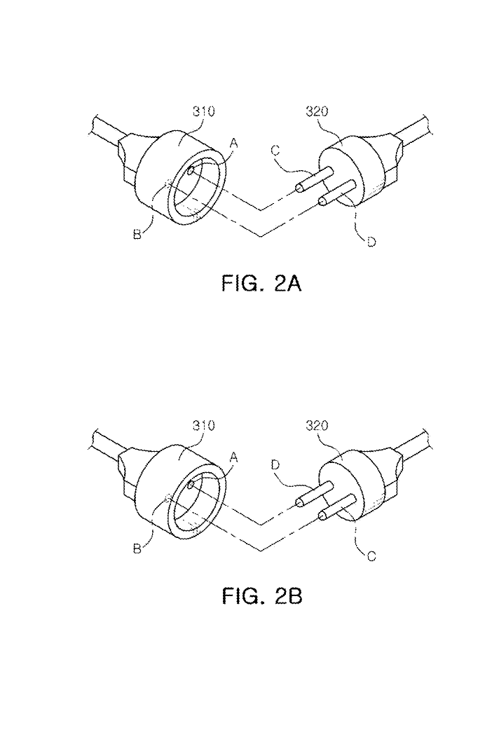

The driving device 100 and the light emitting device 200 may be physically separated from one another without being destroyed or damaged, and may be detachably and electrically connected to one another via the electrical connector 300. As illustrated in FIGS. 2A and 2B, the electrical connector 300 may be provided as a socket 310 formed in the driving device 100 and a plug 320 formed in the light emitting device 200, or the plug 320 formed in the driving device 100 and the socket 310 formed in the light emitting device 200. However, the electrical connector is not limited thereto, and any of a general connector, a general socket, or the like, able to detachably and electrically connect the driving device 100 and the light emitting device 200, may be used for the electrical connector 300.

The driving device 100 may include a rectifier 110 receiving alternating current (AC) power from an external power source 10 and rectifying the AC power, and a constant current driver 120 receiving the rectified power output from the rectifier 110 and outputting constant current.

The rectifier 110 may be a bridge diode full-wave rectifying the AC power, but is not limited thereto. Alternatively, the rectifier 110 may be configured in a manner of half-wave rectification.

The constant current driver 120 may be configured as a driver known in the art, such as a switching- or linear-type constant current regulator, a constant current integrated circuit (IC) chip, or the like, which is able to receive power and output constant current.

The light emitting device 200 may include at least one light emitting diode (LED) 220 driven with the constant current from the driving device 100. Since the LED emits light through current flowing from an anode to a cathode, the constant current from the driving device 100 should be applied to the LED 220 in a forward direction. With reference to FIG. 1, the anode of the LED 220 of the light emitting device 200 is required to be electrically connected to a connection member A of the driving device 100 from which the constant current thereof is output in the forward direction.

Meanwhile, in the illumination system 500 according to an exemplary embodiment, the driving device 100 and the light emitting device 200 may be attachable to and detachable from one another as described above, and when they are connected to one another by the electrical connector 300, they may, for example, make polarity connections as illustrated in FIG. 2A. That is, the connection member A of the driving device 100 may be connected to the connection member C of the light emitting device 200, and the connection member B of the driving device 100 may be connected to the connection member D of the light emitting device 200. On the contrary, as illustrated in FIG. 2B, the connection member A of the driving device 100 may be connected to the connection member D of the light emitting device 200, and the connection member B of the driving device 100 may be connected to the connection member C of the light emitting device 200. Here, the connection members A and B may be socket receptacles, and the connection members C and D may be pins.

Therefore, the light emitting device 200 in the illumination system 500 according to an exemplary embodiment may include a forward direction current transmitter 210 in order to allow the driving device 100 and the light emitting device 200 to operate normally, regardless of how they are configured to be connected to one another by the electrical connector 300.

The forward direction current transmitter 210 may receive the constant current from the driving device 100, and control the constant current from the driving device 100 to be applied to the LED 220 in the forward direction. For example, the forward direction current transmitter 210 may include a bridge diode. However, the forward direction current transmitter 210 is not limited thereto, and any element able to apply the constant current from the driving device 100 to the LED 220 in the forward direction may correspond to the forward direction current transmitter 210.

Accordingly, the light emitting device 200 may allow the constant current received from the driving device 100 to be applied to the LED 220 in the forward direction, regardless of the polarity connection state between the driving device 100 and the light emitting device 200.

In an exemplary embodiment, the light emitting device 200 may further include a protection circuit 230 preventing the application of overcurrent to the LED 220. The protection circuit 230 may include a Zener diode connected to the LED 220 in parallel. Alternatively, the protection circuit 230 may include a switching unit connected to the LED 220 in series, and the switching unit may detect the current applied to the LED 220, compare the detected current with a predetermined value, and be switched off when the detected current is determined as being overcurrent.

In addition, as illustrated in FIG. 1, the light emitting device 200 according to an exemplary embodiment may include four LEDs 220 connected to one another in series; however, the number of LEDs 220 and the serial or parallel connections between the LEDs 220 may be appropriately varied as necessary.

In the illumination system 500 according to an exemplary embodiment, a separate driving circuit such as the constant current driver 120 is not mounted within the light emitting device 200, so that the degree of freedom in designing the light emitting device 200 in addition to the mounting of the LEDs 220 may be improved, and a heating problem may be effectively reduced. In a case in which any one of the lifespans of the driving device 100 and the light emitting device 200 expires, a problem of replacing the entirety of the illumination system may be effectively addressed.

In addition, illumination system utilization may be enhanced by selecting or combining the light emitting devices 200 having different characteristics in terms of driving current, the number of LEDs, an overall volume of the light emitting device, or the like, according to an intended purpose. In addition, an existing stabilizer having a voltage drop function decreasing a high voltage of commercial AC power to a low voltage and the driving circuit are combined to thereby enhance the efficiency of the illumination system.

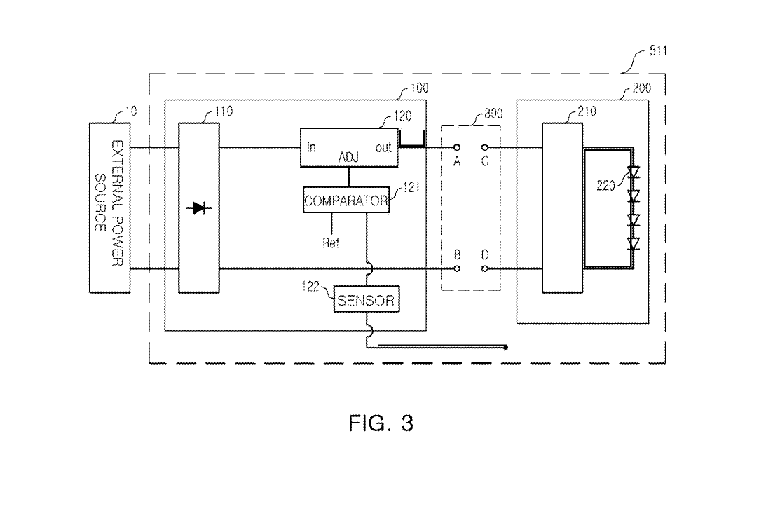

FIGS. 3 through 5 are block diagrams of illumination systems according to exemplary embodiments.

With reference to FIGS. 3 through 5, illumination systems 511, 512 and 513 according to exemplary embodiments may further include a comparator 121 in the constant current driver 120 of the driving device 100, the comparator 121 receiving a signal output from the light emitting device 200 and comparing the output signal with a preset reference signal Ref to thereby output a comparison signal. The constant current driver 120 may control a level of constant current output therefrom according to the comparison signal of the comparator 121.

More specifically, as illustrated in FIG. 3, the output signal of the light emitting device 200 may be obtained from a sensor 122 included in the comparator 121. The sensor 122 may be an optical sensor or a temperature sensor.

In a case in which the optical sensor is employed, the output signal of the light emitting device 200 may be an amount of light output from the light emitting device 200. In a case in which the temperature sensor is employed, the output signal of the light emitting device 200 may be an amount of heat emitted from the light emitting device 200.

The comparator 121 may receive the sensed value from the sensor 122 and compare the sensed value with the preset reference signal Ref to thereby output the comparison signal to the constant current driver 120, and the constant current driver 120 may control the level of the constant current output therefrom according to the comparison signal.

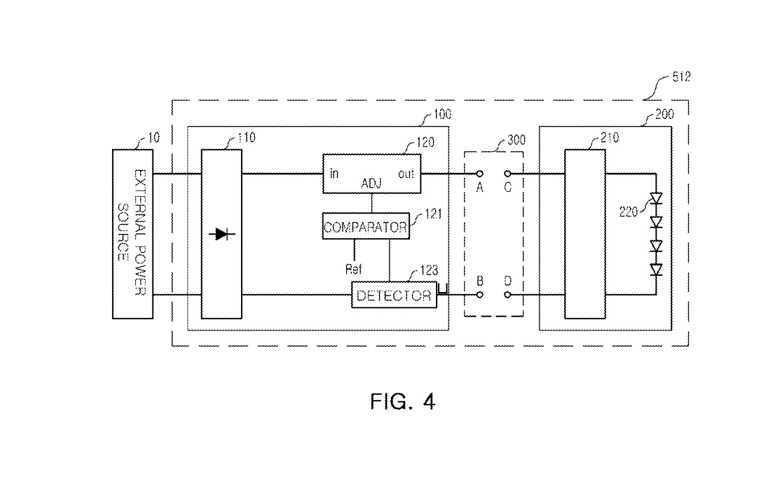

In addition, as illustrated in FIG. 4, the output signal of the light emitting device 200 may be detected by a detector 123 included in the comparator 121, and may be a current value or a voltage value applied from the light emitting device 200 to the driving device 100. For example, the detector 123 may detect a level of current or voltage flowing through the LEDs 220 of the light emitting device 200 and returning back to the driving device 100, and the comparator 121 may receive the current value or the voltage value detected by the detector 123 and compare the detected value with a preset reference signal Ref to thereby output a comparison signal. The constant current driver 120 may control a level of the constant current output therefrom according to the comparison signal.

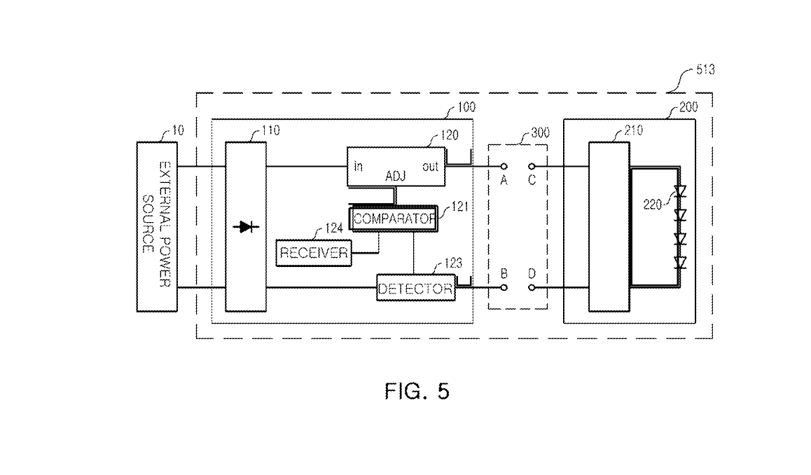

Meanwhile, as illustrated in FIG. 5, the comparator 121 may receive a reference signal Ref from an external source. With reference to FIG. 5, the comparator 121 may include a receiver 124 that receives the reference signal Ref from the external source and the reference signal Ref received from the receiver may be applied to the comparator 121.

In this case, the comparator 121 may receive the output signal of the light emitting device 200 and compare the output signal with the reference signal Ref received from the receiver 124 to thereby output a comparison signal. The constant current driver 120 may control a level of the constant current output therefrom according to the comparison signal.

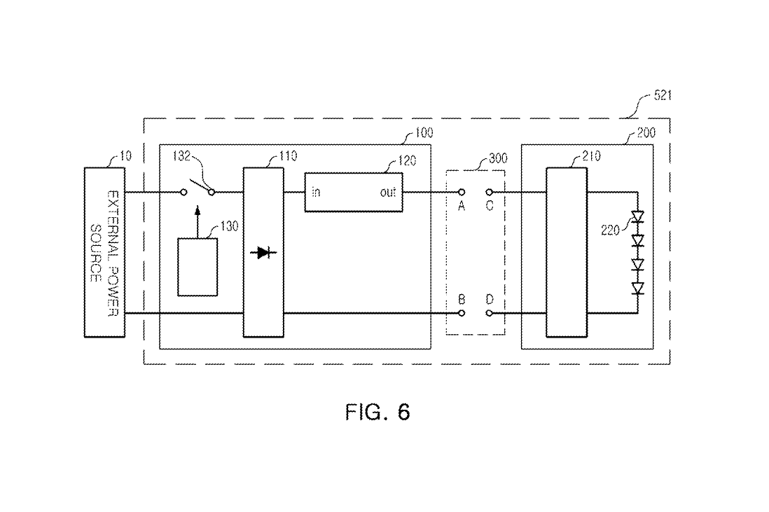

FIGS. 6 through 8 are block diagrams of illumination systems according to exemplary embodiments.

With reference to FIGS. 6 through 8, illumination systems 521, 522 and 523 according to exemplary embodiments may further include an operation controller 130 in the driving device 100, the operation controller 130 receiving an operation control signal from an external source and controlling the operations of the driving device 100.

More specifically, as illustrated in FIG. 6, the operation controller 130 may receive an operation control signal for controlling on/off operations of the driving device 100 from an external source and control the on/off operations of the driving device 100. In this case, the operation controller 130 may further include a switching unit 132.

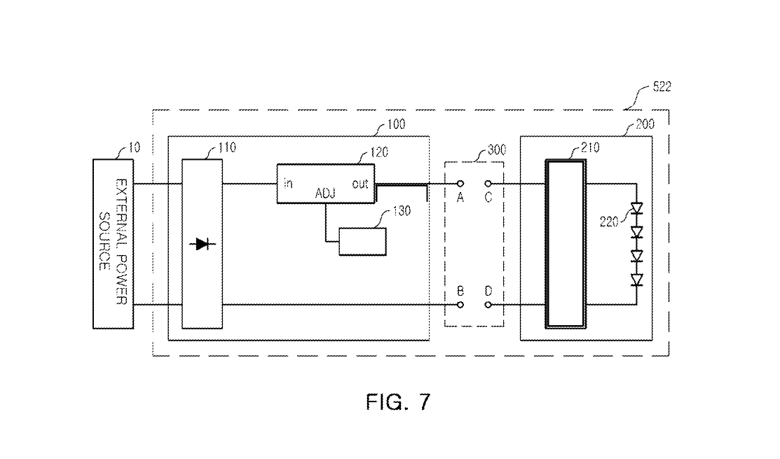

In addition, as illustrated in FIG. 7, the operation controller 130 may receive a signal for controlling an amount of light output from the light emitting device 200 from an external source and control a level of the constant current output from the constant current driver 120 of the driving device 100. In this case, the output of the operation controller 130 may be input to the constant current driver 120.

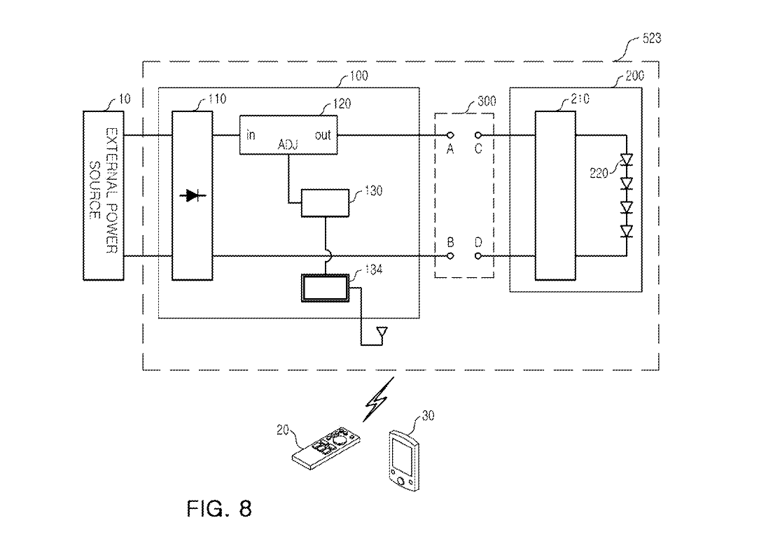

Meanwhile, as illustrated in FIG. 8, the operation controller 130 may include a wireless communications unit 134. The operation controller 130 may receive an operation control signal from the wireless communications unit 134.

More specifically, the wireless communications unit 134 may receive a wireless signal from an external wireless input unit 20 using RF communications, or may include a wireless receiver module receiving wireless data from a terminal 30 of a user through a wireless communications server. The operation controller 130 may output the control signal for controlling the on/off operations of the driving device 100 and a level of the constant current output from the constant current driver 120 of the driving device 100 according to the wireless signal or the wireless data input to the wireless communications unit 134.

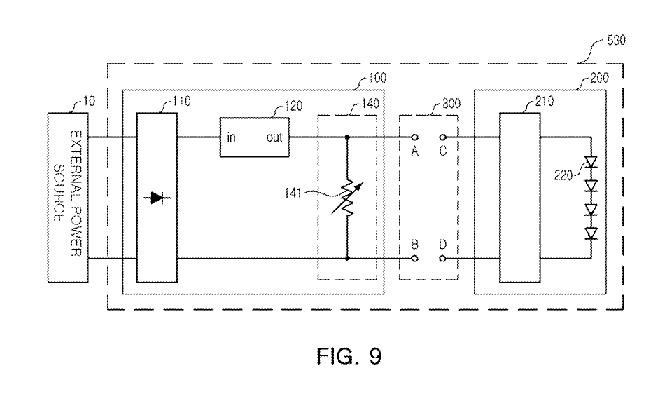

FIG. 9 is a block diagram of an illumination system according to another exemplary embodiment.

With reference to FIG. 9, an illumination system 530 according to an exemplary embodiment may further include a current regulator 140 in the driving device 100, the current regulator 140 varying an amount of the constant current output from the constant current driver 120 and applied to the light emitting device 200.

The current regulator 140 may include a variable resistor 141 connected to a constant current output terminal of the constant current driver 120 in parallel, such that the amount of the constant current output from the constant current driver 120 and applied to the light emitting device 200 may be varied by adjusting resistance of the variable resistor 141.

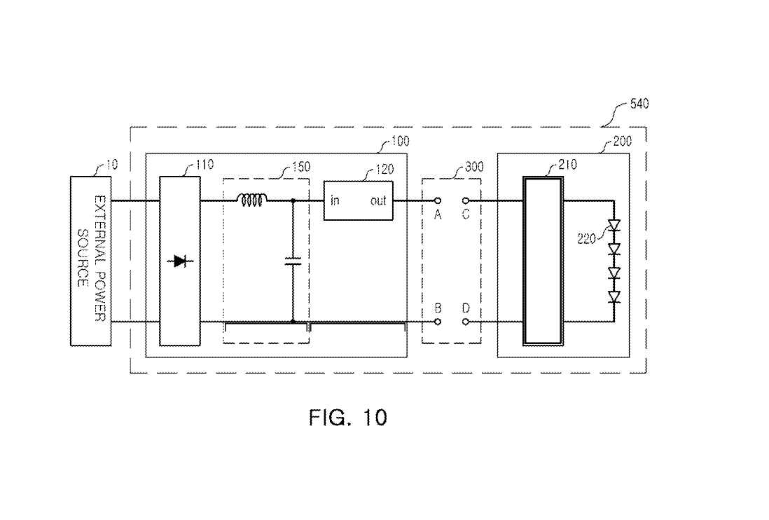

FIG. 10 is a block diagram of an illumination system according to another exemplary embodiment.

With reference to FIG. 10, an illumination system 540 according to another exemplary embodiment may further include a filter 150 in the driving device 100, the filter 150 reducing noise in the rectified power output from the rectifier 110. The constant current driver 120 may receive the power in which noise is reduced by the filter 150 to thereby output the constant current.

For example, the filter 150 may include a low pass filter including an inductor and a capacitor and transmitting the power, in which current and voltage variations are effectively reduced, to the constant current driver 120, but is not limited thereto.

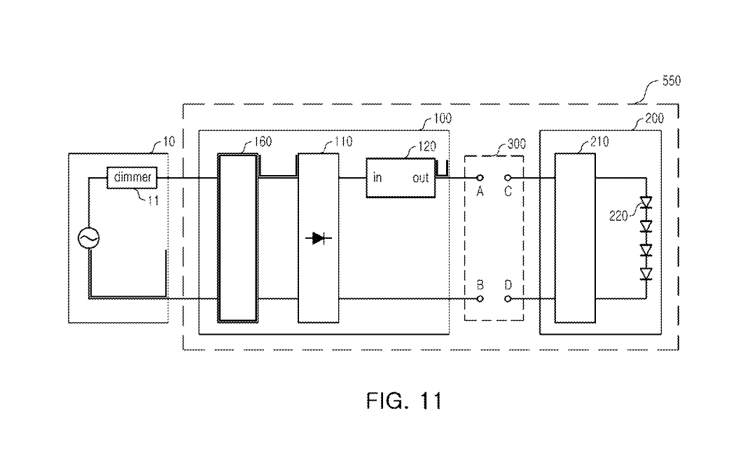

FIG. 11 is a block diagram of an illumination system according to another exemplary embodiment.

With reference to FIG. 11, the driving device 100 in an illumination system 550 according to another exemplary embodiment may receive AC power from the external power source 10 including a dimmer 11.

In general, a triac dimmer controls a level of voltage by adjusting a conduction angle of AC voltage. In order for the triac dimmer to operate normally, a minimum amount of hold current should be maintained. However, an illumination system using LEDs is usually driven with low current, so it may be difficult to obtain compatibility with the AC power source including the triac dimmer. That is, in a case in which a conduction angle set by the triac dimmer is equal to or less than a predetermined angle, the triac dimmer may fail to maintain a minimum amount of hold current and be turned off. In addition, the LEDs may suffer from flickers. Furthermore, the triac dimmer uses a voltage control method of controlling a level of voltage by adjusting a conduction angle of AC voltage, while the LEDs control an amount of light using a current control method, whereby the triac dimmer may be difficult to be compatible with the illumination system using the LEDs.

Therefore, the driving device 100 may further include a dimmer compatible unit 160. The dimmer compatible unit 160 may receive the AC power dimmed by the dimmer 11 included in the external power source, thereby improving compatibility between the driving device 100 and the AC power source. The dimmer compatible unit 160 may be configured as various types of dimming stabilizers known in the art.

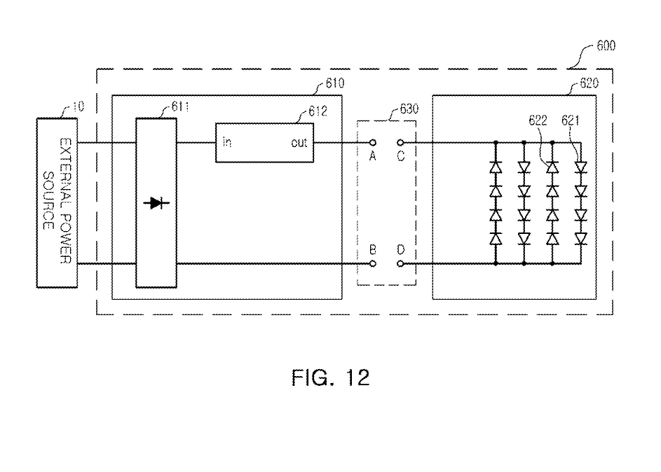

FIG. 12 is a block diagram of an illumination system according to another exemplary embodiment.

With reference to FIG. 12, an illumination system 600 according to another exemplary embodiment may include a driving device 610, a light emitting device 620 and an electrical connector 630 allowing the driving device 610 and the light emitting device 620 to be detachably and electrically connected to one another.

As described above, the driving device 610 and the light emitting device 620 may be physically separated from one another without being destroyed or damaged, and may be detachably and electrically connected to one another via the electrical connector 630. As illustrated in FIGS. 2A and 2B, the electrical connector 630 may be provided as the socket 310 formed in the driving device 610 and the plug 320 formed in the light emitting device 620, or as the plug 320 formed in the driving device 610 and the socket 310 formed in the light emitting device 620. However, the electrical connector is not limited thereto, and any of a general connector, a general socket, or the like, able to detachably and electrically connect the driving device 610 and the light emitting device 620, may be used for the electrical connector 630.

In addition, the driving device 610 may include a rectifier 611 receiving AC power from the external power source 10 and rectifying the AC power, and a constant current driver 612 receiving the rectified power output from the rectifier 611 and outputting constant current.

The light emitting device 620 may include at least one first LED 621 driven with the constant current from the driving device 610, and at least one second LED 622 connected to the at least one first LED 621 in parallel while making an opposite polarity connection.

In another exemplary embodiment, the second LED 622 may be substituted for the forward direction current transmitter 210 of the light emitting device 200 in the exemplary embodiment of FIG. 1.

Specifically, when the driving device 610 and the light emitting device 620 are connected to one another by the electrical connector 630, in a case in which they make the polarity connections as illustrated in FIG. 2A, that is, the connection member A of the driving device 610 is connected to the connection member C of the light emitting device 620 and the connection member B of the driving device 610 is connected to the connection member D of the light emitting device 620, the first LED 621 may be turned on to emit light and the second LED 622 may be in a non-light emitting state.

On the contrary, when the driving device 610 and the light emitting device 620 are connected to one another by the electrical connector 630, in a case in which they make the polarity connections as illustrated in FIG. 2B, that is, the connection member A of the driving device 610 is connected to the connection member D of the light emitting device 620, and the connection member B of the driving device 610 is connected to the connection member C of the light emitting device 620, the second LED 622 may be turned on to emit light and the first LED 621 may be in a non-light emitting state.

That is, the light emitting device 620 in the illumination system 600 according to another exemplary embodiment does not require the forward direction current transmitter 210 as well as a constant current driver 612, and a minimum number of other elements than light emitting elements (the LEDs 621 and 622) are mounted within the light emitting device 620, so that the degree of freedom in designing the light emitting device 620 in addition to the mounting of the LEDs 621 and 622 may be improved, and a heating problem may be effectively reduced. In a case in which any one of the lifespans of the driving device 610 and the light emitting device 620 expires, a problem of replacing the entirety of the illumination system may be effectively addressed. In addition, in a case in which the lifespan of the first LED 621 of the light emitting device 620 expires, the second LED 622 may be used to emit light by simply changing the polarity connection state of the electrical connector 630. In this manner, the replacement period of the light emitting device 620 may be effectively extended.

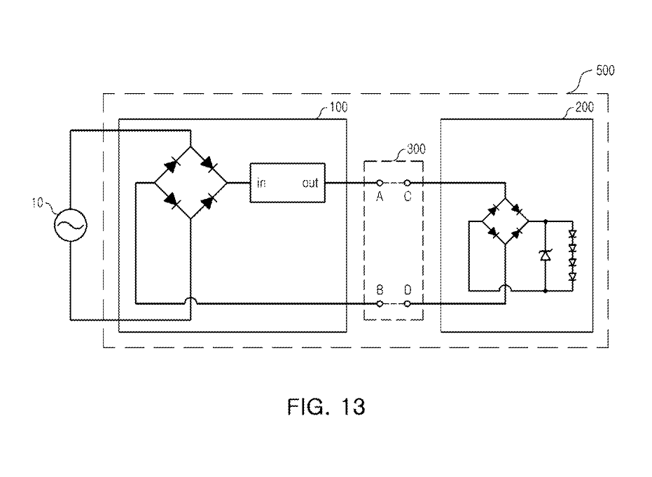

FIG. 13 is a circuit diagram of the illumination system of FIG. 1.

Here, an actual circuit model for the illumination system 500 of FIG. 1 is schematically exemplified, and is not intended to limit the exemplary embodiment of FIG. 1.

As set forth above, according to exemplary embodiments, an illumination system may achieve the miniaturization of a circuit mounted within a light emitting device and extend a replacement period thereof.

While exemplary embodiments have been shown and described above, it will be apparent to those skilled in the art that modifications and variations could be made without departing from the spirit and scope of the inventive concept as defined by the appended claims.

What is claimed is:

1. An illumination system comprising:
a driving device comprising:
a rectifier configured to receive alternating current (AC) power from an external power source, rectify the AC power and output rectified power; and
a constant current driver configured to receive the rectified power from the rectifier and output a constant current;
a light emitting device comprising:
at least one light emitting diode (LED) driven with the constant current of the driving device; and
a forward direction current transmitter configured to control the constant current of the driving device to be applied to the LED in a forward direction; and
a detachable electrical connector connecting the driving device and the light emitting device to one another.

2. The illumination system of claim 1, wherein the detachable electrical connector comprises a socket disposed in the driving device and a plug disposed in the light emitting device, or comprises a plug disposed in the driving device and a socket disposed in the light emitting device.

3. The illumination system of claim 1, wherein the constant current driver comprises a comparator configured to receive a signal output from the light emitting device, compare the output signal with a preset reference signal, and output a comparison signal, and
wherein the constant current driver controls a level of the constant current based on the comparison signal of the comparator.

4. The illumination system of claim 3, wherein the comparator comprises a receiver configured to receive the preset reference signal from an external source.

5. The illumination system of claim 3, wherein the signal output from the light emitting device comprises information about at least one from among an amount of light output from the light emitting device, an amount of heat emitted from the light emitting device, a current value applied from the light emitting device to the driving device, and a voltage value applied from the light emitting device to the driving device.

6. The illumination system of claim 1, further comprising an operation controller configured to receive an operation control signal from an external source and control at least one from among on/off operations of the driving device and a level of the constant current output from the driving device.

7. The illumination system of claim 6, wherein the operation controller comprises a wireless communications device, and receives the operation control signal from the external source through the wireless communications device.

8. The illumination system of claim 1, wherein the driving device further comprises a current regulator configured to vary an amount of the constant current outputted from the constant current driver and applied to the light emitting device.

9. The illumination system of claim 8, wherein the current regulator comprises a variable resistor.

10. The illumination system of claim 1, wherein the driving device further comprises a filter configured to reduce noise in the rectified power output from the rectifier, and
wherein the constant current driver receives the power output from the filter and outputs the constant current.

11. The illumination system of claim 10, wherein the filter comprises a low pass filter.

12. The illumination system of claim 1, wherein the driving device further comprises a dimmer compatible device, and
wherein the dimmer compatible device is configured to receive AC power dimmed by a dimmer included in the external power source.

13. The illumination system of claim 1, wherein the forward direction current transmitter comprises a bridge diode.

14. The illumination system of claim 1, wherein the light emitting device further comprises a protection circuit configured to prevent an overcurrent from being applied to the LED.

15. An illumination system comprising:
a driving device comprising:
a rectifier configured to receive AC power from an external power source, rectify the AC power, and output rectified power; and
a constant current driver configured to receive the rectified power from the rectifier and output a constant current;
a light emitting device comprising:
at least one first LED driven with the constant current of the driving device; and
at least one second LED connected to the at least one first LED in parallel while making an opposite polarity connection; and
a detachable electrical connector connecting the driving device and the light emitting device to one another.

16. An illumination system comprising:
a driving device comprising a rectifier and a constant current driver;
a light emitting device comprising at least one light emitting diode (LED) and a forward direction current transmitter; and
a detachable electrical connector connecting the driving device and the light emitting device.

17. The illumination system of claim 16, wherein the detachable electrical connector comprises a socket disposed in the driving device and a plug disposed in the light emitting device.

18. The illumination system of claim 16, wherein the detachable electrical connector comprises a plug disposed in the driving device and a socket disposed in the light emitting device.
